(19) United States
(12) Patent Application Publication
(10) Pub. No.: US 2026/0041156 A1
(43) Pub. Date: Feb. 12, 2026

(54) SUSCEPTOR ASSEMBLY FOR AN AEROSOL-GENERATING SYSTEM AND METHOD OF MANUFACTURE THEREOF

(71) Applicant: Philip Morris Products S.A., Neuchatel (CH)

(72) Inventors: Olivier BLÄTTLER, Lamboing (CH); David Murray CROSS, Hertfordshire (GB); Onur DAYIOGLU, Neuchâtel (CH); Amir FERIANI, Saint-Blaise (CH); Emeric Romain GRANDJEAN, Lausanne (CH); Stuart Michael Ruan JONES, Hertfordshire (GB); Dominique Paul Gabriel STOHR, Belfaux (CH)

(73) Assignee: Philip Morris Products S.A., Neuchatel (CH)

(21) Appl. No.: 19/099,339

(22) PCT Filed: Jul. 20, 2023
(86) PCT No.: PCT/EP2023/070205

§ 371 Date: Jan. 28, 2025

(30) Foreign Application Priority Data
Aug. 11, 2022 (EP) 22189943.8

(51) Int. Cl. A24F 40/465; A24F 40/10; A24F 40/42; A24F 40/44; A24F 40/485; A24F 40/51; A24F 40/70; H05B 6/10

(52) U.S. Cl. CPC A24F 40/465; A24F 40/10; A24F 40/42; A24F 40/44; A24F 40/485; A24F 40/51; A24F 40/70; H05B 6/108

(57) ABSTRACT

A susceptor assembly for an aerosol-generating system is provided, the susceptor assembly including: a wicking element having first and second planar surfaces, the first and the second planar surfaces defining opposite, outward-facing surfaces of the wicking element; and a susceptor element including an arrangement of a single strip of susceptor material, the arrangement of the single strip being wrapped around a central region of the wicking element to overlie the first and the second outward-facing surfaces of the wicking element and enclose a central region of the wicking element, the single strip extending over a length between first and second ends, the single strip wrapping around the central region of the wicking element such that the first and the second ends extend from opposite directions along a side face of the wicking element, the side face extending between the first and the second planar outward-facing surfaces.

The present disclosure relates to a susceptor assembly for an aerosol-generating system, and a method of manufacture thereof. More particularly, the present disclosure relates to a susceptor assembly for an inductively heated aerosol-generating system.

Aerosol-generating systems configured to generate inhalable aerosol from a liquid aerosol-forming substrate are known in the art. It is known for such systems to employ an inductive heating mechanism in order to generate heat for vapouring the aerosol-forming substrate. Inductive heating mechanisms typically include a coil arranged around a susceptor element. Where the aerosol-forming substrate is a liquid aerosol-forming substrate, a wicking element is provided to convey liquid from a reservoir of the liquid aerosol-forming substrate towards the susceptor element. Alternating current flow through the drive coil induces eddy currents into the susceptor element, thereby heating the susceptor element. The heat from the susceptor element vaporises liquid aerosol-forming substrate entrained in the wicking element in the vicinity of the susceptor element. An airflow passing over the susceptor element entrains the vapor. The entrained vapour cools and condenses to form an aerosol, with the aerosol being inhaled by a user.

It is desirable to provide improved thermal coupling between a susceptor element and wicking element for use in an inductive aerosol-generating system.

In accordance with a first embodiment of the present disclosure, there is provided a susceptor assembly for an aerosol-generating system, the susceptor assembly comprising:
a wicking element having first and second planar surfaces, the first and second surfaces defining opposite, outward-facing surfaces of the wicking element; and
a susceptor element comprising an arrangement of one or more strips of susceptor material, the arrangement of one or more strips wrapped around a central region of the wicking element to overlie the first and second outward-facing surfaces of the wicking element and enclose the central region of the wicking element.

Having the one or more strips arranged to wrap around a central region of the wicking element to enclose the central region may increase the surface area of the susceptor element in contact with the wicking element, thereby promoting increased heat transfer between the susceptor element and the wicking element. In use, increased heat transfer from the susceptor element to the wicking element may enhance the generation of vapour from liquid aerosol-forming substrate entrained in the wicking element.

As used herein, the term “aerosol-generating device” is used to describe a device that interacts with an aerosol-forming substrate to generate an aerosol. Preferably, the aerosol-generating device is a smoking device that interacts with an aerosol-forming substrate to generate an aerosol that is directly inhalable into a user's lungs thorough the user's mouth.

As used herein, the term “aerosol-forming substrate” refers to a substrate consisting of or comprising an aerosol-forming material that is capable of releasing volatile compounds upon heating to generate an aerosol.

As used herein, the term “liquid” refers to a substance provided in liquid form and encompasses substances provided in the form of a gel.

As used herein, a “susceptor element” means an element that is heatable by penetration with an alternating magnetic field. A susceptor element is typically heatable by at least one of Joule heating through induction of eddy currents in the susceptor element, and hysteresis losses. Suitable materials for the arrangement of one or more strips forming the susceptor element include graphite, molybdenum, silicon carbide, stainless steels, niobium, aluminium and other conductive materials. Advantageously, the one or more strips may be formed of ferromagnetic material. Preferably, the one or more strips may be formed of AISI 430 stainless steel.

The one or more strips forming the susceptor element may have a relative permeability between 1 and 40000, when measured at a suitable frequency and temperature; for example, when measured at frequencies up to 10 kHz at a temperature of 20 degrees Celsius. When a reliance on eddy currents for a majority of the heating is desirable, a lower permeability material may be used, and when hysteresis effects are desired then a higher permeability material may be used. Preferably, the material has a relative permeability between 500 and 40000. This may provide for efficient heating of the one or more strips forming the susceptor element.

The one or more strips forming the susceptor element may be fluid permeable. As used herein, a “fluid permeable” element means an element that allows liquid or gas to permeate through it. A fluid permeable susceptor element may advantageously allow vaporised aerosol-forming substrate to escape through the susceptor element. The one or more strips forming the susceptor element may comprise a mesh. As used herein, the term “mesh” encompasses grids and arrays of filaments having spaces therebetween. The term mesh also includes woven and non-woven material. In use, vaporised aerosol-forming substrate may advantageously escape from the wicking element through interstices present in the susceptor element when employing a meshed construction for the one or more strips. The wicking element provides wetting of the susceptor element during use of the susceptor assembly. The wicking element may comprise a capillary material. A capillary material is a material that is capable of transporting liquid from one end of the material to another by means of capillary action. The capillary material may have a fibrous or spongy structure. The capillary material preferably comprises a bundle of capillaries. For example, the capillary material may comprise a plurality of fibres or threads or other fine bore tubes. In some embodiments, the capillary material may comprise sponge-like or foam-like material. The structure of the capillary material may form a plurality of small bores or tubes, through which the liquid aerosol-forming substrate can be transported by capillary action. Where the one or more strips comprise interstices, the capillary material may extend into the interstices. In use, liquid aerosol-forming substrate may be drawn into the interstices by capillary action. The wicking element may comprise or consist of an electrically insulating material. The wicking element may comprise a non-metallic material. The wicking element may comprise a hydrophilic material or an oleophilic material. This may advantageously encourage the transport of the aerosol-forming substrate through the wicking element.

The wicking element may preferably comprise or consist of cotton, rayon or glass fibre.

Advantageously, the arrangement of one or more strips may be wrapped around the central region of the wicking element so as to compress the central region. Compression of the wicking element by the arrangement of one or more strips increases contact pressure between corresponding surfaces of the one or more strips and the wicking element. Such increased contact pressure may facilitate enhancing heat transfer between the one or more strips and the wicking element, thereby providing enhanced vapour generation from liquid aerosol-forming substrate entrained in the wicking element.

Each of the one or more strips may extend over a length between first and second ends, either or both of the first and second ends of at least one of the one or more strips of susceptor material folded inwardly towards the wicking element. Having an end of a given strip folded inwardly towards the wicking element may obscure a free edge of the end of the strip from view to reduce the risk of debris being snagged on the free edge, as well as providing a smoother appearance to the susceptor element of the susceptor assembly.

Preferably, each of the one or more strips may extend over a length between first and second ends, either or both of the first and second ends of at least one of the one or more strips folded inwardly to embed within the wicking element. Having the one or more strips folded inwardly to embed within the wicking element may enhance mechanical coupling between the strip and the wicking element, and inhibit detachment of the strip from the wicking element. Embedding within the wicking element would also inhibit debris becoming caught on the end of the respective strip. Fraying of the strip may also be inhibited as a consequence of embedding an end of the strip within the wicking element; for example, where the strip has a woven meshed construction or similar.

Advantageously, each of the one or more strips may extend over a length between first and second ends, the wicking element comprising a first planar layer overlying a second planar layer. Either or both of the first and second ends of at least one of the one or more strips may be folded inwardly to wrap around a side face of one of the first layer and the second layer to tuck between the first and second layers. Having an end of a given strip wrapped around a side face of the one of the first and second layers to tuck between the layers may enhance mechanical coupling between the strip and the wicking element, and potentially inhibit detachment of the strip from the wicking element. Additionally, having the end of the strip tucked between the first and second layers may also inhibit debris being snagged on the end of the strip. Fraying of the strip may also be inhibited; for example, where the strip has a woven meshed construction or similar.

Each of the one or more strips may extend over a length between first and second ends, either or both of the first and second ends of at least one of the one or more strips folded inwardly back over the strip so as to overlie an inward-facing surface of the strip and form a folded end. In this manner, a free edge of the folded end of the strip may be obscured from view, thereby inhibiting debris becoming snagged on the free edge. The use of a folded end on the strip may also inhibit fraying of the strip; for example, where the strip has a woven meshed construction or similar.

Preferably, the susceptor element comprises an arrangement of a single strip of susceptor material.

The single strip may be formed as a continuous loop.

The single strip may extend over a length between first and second ends, the strip wrapping around the central region of the wicking element such that the first and second ends extend towards each other from opposite directions along a side face of the wicking element. The side face extends between the first and second planar outward-facing surfaces of the wicking element. In this manner, the strip may enclose the central region of the wicking element.

The wicking element may have a thickness defined by the side face of the wicking element.

The first and second ends may be folded ends.

Conveniently, the first and second ends may be separated from each other by a gap along the side face of the wicking element, the gap being less than a thickness of the wicking element.

The first and second ends may be in surface contact, overlie or intermesh with each other, or a combination thereof. In this manner, inadvertent detachment of the strip from the wicking element may be inhibited.

Each of the first and second ends of the strip may be folded inwardly towards the side face of the wicking element. Having each end of the strip folded inwardly towards the wicking element may obscure a free edge of each of the respective ends of the strip from view, thereby inhibiting snagging of debris on the free edge, as well as providing a smoother appearance to the susceptor element of the susceptor assembly.

Preferably, each of the first and second ends may be folded inwardly to embed within the side face of the wicking element. Embedding both ends of the strip within the side face of the wicking element may enhance mechanical coupling between the strip and the wicking element, and inhibit detachment of the strip from the wicking element. Also, fraying of the strip may be inhibited; for example, where the strip has a woven meshed construction or similar.

Each of the first and second ends may be folded inwardly back over the strip so as to overlie an inward-facing surface of the strip and form a folded end. In this manner, a free edge of each of the folded ends of the strip may be obscured from view, thereby inhibiting snagging on the free edge. The provision of both ends of the strip as folded ends may also inhibit fraying of the strip; for example, where the strip has a woven meshed construction or similar.

Advantageously, the wicking element may comprise a first planar layer overlying a second planar layer. The first end of the strip may be folded inwardly to wrap around a side face of the first layer to tuck between the first and second layers. The second end of the strip may be folded inwardly to wrap around a side face of the second layer to tuck between the first and second layers. Having both ends of the strip tucked in between the first and second layers may enhance mechanical and thermal coupling between the strip and the wicking element, as well as inhibiting inadvertent detachment of the strip from the wicking element. Further, fraying of the strip may also be inhibited; for example, where the strip has a woven meshed construction or similar.

Preferably, the respective side faces of the first and second planar layers may be aligned with each other.

The tucked-in first and second ends of the strip may be arranged to maintain a clearance between opposing surfaces of the first and second planar layers of the wicking element.

The wicking element may be folded about a fold line. The first planar layer of the wicking element may extend from the fold line to the side face of the first layer, and the second planar layer of the wicking material extend from the fold line to the side face of the second layer. It is preferred that the first layer be aligned parallel to the second layer.

Advantageously, the first end of the strip may comprise a first leg and the second end of the strip comprise a second leg. The first and second legs may be laterally offset from each other and extend in opposite directions from respective first and second adjoining portions of the strip to wrap around the side face of the wicking element. The configuration of the strip may inhibit inadvertent detachment of the susceptor element from the wicking element, and may also enhance mechanical coupling between the susceptor and the wicking element.

Preferably, the first and second legs may be of reduced lateral width relative to the respective adjoining portion of the strip. Further, the first and second legs may be equal in length and arranged in side-by-side, non-overlapping relationship. The use of a side-by-side, non-overlapping arrangement of the first and second legs facilitates minimising localised increases in thickness of the susceptor element. Minimising the thickness of the susceptor element may be desirable when the susceptor element is arranged within an air flow channel of an aerosol-generating system, as it may avoid the susceptor element blocking the passage of air therethrough.

The wicking element may be folded about a fold line to define a first planar layer overlying a second planar layer. The first layer may extend from the fold line to a side face of the first layer, and the second layer extend from the fold line to a side face of the second layer. The side faces of the first and second layers may be aligned with each other to form a common side face. The first and second legs may extend in opposite directions to wrap around the common side face.

Preferably, the first and second legs wrap around the common side face such that opposing surfaces of the first and second planar layers of the wicking element are urged into surface contact with each other.

Although the use of a single strip for the susceptor element is preferred, in various alternative embodiments, the susceptor element may comprise an arrangement of a plurality of strips.

Although any number of strips may be used for the susceptor element, reducing the number of strips reduces the complexity in manufacturing the susceptor assembly.

Preferably, the susceptor element may comprise an arrangement of a first strip and a second strip. Each of the first and second strips may extend over a length between first and second ends. The first strip may extend along the first planar, outward-facing surface of the wicking element; and the second strip extend along the second planar, outward-facing surface of the wicking element. So, the first strip is positioned to predominantly thermally couple with the first outward-facing surface of the wicking element, whereas the second strip is positioned to predominantly thermally couple with the second outward-facing surface of the wicking element.

Preferably, the first ends of the first and second strips may be positioned to extend in opposite directions towards each other along a first side face of the wicking element, and the second ends of the first and second strips positioned to extend in opposite directions towards each other along a second side face of the wicking element. Each of the first and second side faces may extend between the first and second planar outward-facing surfaces of the wicking element.

The wicking element may have a thickness defined by the first and second side faces of the wicking element.

The first and second ends of the first and second strips may be folded ends.

In one embodiment, one or both of the following conditions may apply:
a) the first ends of the first and second strips are separated from each other by a gap along the first side face of the wicking element;
b) the second ends of the first and second strips are separated from each other by a gap along the second side face of the wicking element.

Alternatively, in another embodiment one or both of the following conditions apply:
a) the first ends of the first and second strips are in surface contact, overlie or intermesh with each other or a combination thereof;
b) the second ends of the first and second strips are in surface contact, overlie or intermesh with each other or a combination thereof.

Preferably, the wicking element may be folded about a fold line to define a first planar layer overlying a second planar layer. The first layer may extend from the fold line to a side face of the first layer, and the second layer extend from the fold line to a side face of the second layer. The side faces of the first and second layers may be aligned with each other to form a common side face, the first legs extending in opposite directions to wrap around the common side face. The wrapping of the first legs around the common side face may inhibit against the first and second strips becoming detached from the wicking element, as well as helping to keep the first and second layers of the wicking element positioned so as to overly each other.

Advantageously, the first legs may wrap around the common side face such that opposing surfaces of the first and second planar layers of the wicking element are urged into surface contact with each other. This may also enhance contact pressure between opposing surfaces of the first and second strips and the wicking element, thereby enhancing thermal coupling between the susceptor element and the wicking element.

Regardless of whether a single strip, or two or more strips form the susceptor element, preferably the susceptor assembly may further comprise a pair of unwrapped portions of the wicking element extending laterally outward from opposite sides of the wrapped central region of the wicking element. Advantageously, the pair of unwrapped portions may be configured for engaging with a pair of corresponding openings provided on opposing sides of an air flow channel. Such an air flow channel may form part of a cartridge adapted for receiving the susceptor assembly.

In accordance with a further embodiment of the present disclosure, there is provided a cartridge comprising the susceptor assembly according to any one of the variants described herein. The cartridge comprises an internally positioned air flow channel and a reservoir for liquid aerosol-forming substrate, the cartridge configured to receive the susceptor assembly such that the susceptor element is positioned in the air flow channel with the reservoir in fluid communication with the wicking element of the susceptor assembly.

Preferably, the susceptor assembly may comprise a pair of unwrapped portions of the wicking element extending laterally outward from opposite sides of the wrapped central region of the wicking element. The cartridge may further comprise a pair of openings positioned on opposing sides of the air flow channel, the pair of unwrapped portions of the wicking element received in the pair of openings.

Advantageously, the cartridge may comprise a detachable holder, the holder at least partially defining the air flow channel, the holder configured to receive the susceptor assembly such that the susceptor element is positioned in the air flow channel.

In accordance with a further embodiment of the present disclosure, there is provided an aerosol-generating system comprising an aerosol-generating device and a cartridge according to any one of the variants described herein, the aerosol-generating device comprising an inductor that at least in part surrounds the susceptor element when the cartridge is coupled to the aerosol-generating device.

The inductor may be provided in the form of an inductor coil. The inductor coil may comprise a flat spiral inductor coil. The inductor coil may have a tubular shape or a helical shape. Preferably, the inductor coil is both tubular and helical. Preferably, the tubular and helical coil has a non-circular cross section, when viewed in a direction perpendicular to the longitudinal length direction of the coil, i.e. in a direction perpendicular to the magnetic centre-axis of the coil.

In accordance with a further embodiment of the present disclosure, there is provided a method of manufacturing a susceptor assembly comprising steps of:
providing a wicking element having first and second planar surfaces, the first and second planar surfaces defining opposite, outward-facing surfaces of the wicking element;
providing one or more strips of susceptor material;
wrapping the one or more strips around a central region of the wicking element to form an arrangement of the one or more strips overlying the first and second outward-facing surfaces of the wicking element and enclosing the central region of the wicking element.

Such a method may be employed to manufacture the susceptor assembly as described in previous paragraphs of this disclosure.

Preferably, the step of wrapping the one or more strips around a central region of the wicking element may comprise performing a series of folding operations on the one or more strips.

Advantageously, the step of wrapping the one or more strips around a central region of the wicking element may be performed such that the one or more strips compress the central region of the wicking element.

In accordance with a further embodiment of the present disclosure, there is provided a method of manufacturing a susceptor assembly comprising steps of:
providing a sheet of wicking material;
providing one or more strips of susceptor material;
wrapping the one or more strips together with the sheet of wicking material to fold a first portion of the sheet of wicking material over a second portion of the sheet of wicking material to form a wicking element from the sheet of wicking material, wherein the one or more strips are wrapped around a central region of the wicking element to form an arrangement of the one or more strips overlying first and second outward-facing surfaces of the wicking element and enclosing the central region of the wicking element.

Preferably, wrapping the one or more strips around a central region of the wicking element may comprise performing a series of folding operations on the one or more strips.

Advantageously, wrapping the one or more strips around a central region of the wicking element may be performed such that the one or more strips compress the central region of the wicking element.

The invention is defined in the claims. However, below there is provided a non-exhaustive list of non-limiting examples. Any one or more of the features of these examples may be combined with any one or more features of another example, embodiment, or aspect described herein.

Example Ex1: A susceptor assembly for an aerosol-generating system, the susceptor assembly comprising:
a wicking element having first and second planar surfaces, the first and second surfaces defining opposite, outward-facing surfaces of the wicking element; and
a susceptor element comprising an arrangement of one or more strips of susceptor material, the arrangement of one or more strips wrapped around a central region of the wicking element to overlie the first and second outward-facing surfaces of the wicking element and enclose the central region of the wicking element.

Example Ex2: The susceptor assembly according to Ex1, wherein the arrangement of one or more strips is wrapped around the central region of the wicking element so as to compress the central region.

Example Ex3: The susceptor assembly according to either one of Ex1 or Ex2, wherein each of the one or more strips extends over a length between first and second ends, either or both of the first and second ends of at least one of the one or more strips of susceptor material folded inwardly towards the wicking element.

Example Ex4: The susceptor assembly according to any one of Ex1 to Ex3, wherein each of the one or more strips extends over a length between first and second ends, either or both of the first and second ends of at least one of the one or more strips is folded inwardly to embed within the wicking element.

Example Ex5: The susceptor assembly according to any one of Ex1 to Ex4, wherein each of the one or more strips extends over a length between first and second ends, the wicking element comprising a first planar layer overlying a second planar layer, either or both of the first and second ends of at least one of the one or more strips is folded inwardly to wrap around a side face of one of the first layer and the second layer to tuck between the first and second layers.

Example Ex6: The susceptor assembly according to any one of Ex1 to Ex5, wherein each of the one or more strips extends over a length between first and second ends, either or both of the first and second ends of at least one of the one or more strips is folded inwardly back over the strip so as to overlie an inward-facing surface of the strip and form a folded end.

Example Ex7: The susceptor assembly according to any one of Ex1 to Ex6, wherein the susceptor element comprises an arrangement of a single strip of susceptor material.

Example Ex8: The susceptor assembly according to Ex7, wherein the single strip is formed as a continuous loop.

Example Ex9: The susceptor assembly according to Ex7, wherein the single strip extends over a length between first and second ends, the strip wrapping around the central region of the wicking element such that the first and second ends extend towards each other from opposite directions along a side face of the wicking element, the side face extending between the first and second planar outward-facing surfaces of the wicking element.

Example Ex10: The susceptor assembly according to Ex9, wherein the wicking element has a thickness defined by the side face of the wicking element.

Example Ex11: The susceptor assembly according to either one of Ex9 or Ex10, wherein the first and second ends are folded ends.

Example Ex12: The susceptor assembly according to any one of Ex9 to Ex11, wherein the first and second ends are separated from each other by a gap along the side face of the wicking element, the gap being less than a thickness of the wicking element.

Example Ex13: The susceptor assembly according to any one of Ex9 to Ex11, wherein the first and second ends are in surface contact, overlie or intermesh with each other or a combination thereof.

Example Ex14: The susceptor assembly according to any one of Ex9 to Ex13, wherein each of the first and second ends of the strip is folded inwardly towards the side face of the wicking element.

Example Ex15: The susceptor assembly according to any one of Ex9 to Ex14, wherein each of the first and second ends is folded inwardly to embed within the side face of the wicking element.

Example Ex16: The susceptor assembly according to any one of Ex9 to 13, wherein each of the first and second ends is folded inwardly back over the strip so as to overlie an inward-facing surface of the strip and form a folded end.

Example Ex17: The susceptor assembly according to any one of Ex9 to Ex14, wherein the wicking element comprises a first planar layer overlying a second planar layer, wherein the first end of the strip is folded inwardly to wrap around a side face of the first layer to tuck between the first and second layers, and the second end of the strip is folded inwardly to wrap around a side face of the second layer to tuck between the first and second layers.

Example Ex18: The susceptor assembly according to Ex17, wherein the respective side faces of the first and second planar layers are aligned with each other.

Example Ex19: The susceptor assembly according to either one of Ex17 or Ex18, wherein the tucked-in first and second ends of the strip are arranged to maintain a clearance between opposing surfaces of the first and second planar layers of the wicking element.

Example Ex20: The susceptor assembly according to any one of Ex17 to Ex19, wherein the wicking element is folded about a fold line, in which the first planar layer of the wicking element extends from the fold line to the side face of the first layer and the second planar layer of the wicking material extends from the fold line to the side face of the second layer.

Example Ex21: The susceptor assembly according to either one of Ex17 to Ex20, wherein the first layer is aligned parallel to the second layer.

Example Ex22: The susceptor assembly according to either one of Ex9 or Ex10, wherein the first end of the strip comprises a first leg and the second end of the strip comprises a second leg, the first and second legs laterally offset from each other and extending in opposite directions from respective first and second adjoining portions of the strip to wrap around the side face of the wicking element.

Example Ex23: The susceptor assembly according to Ex22, wherein the first and second legs are of reduced lateral width relative to the respective adjoining portion of the strip.

Example Ex24: The susceptor assembly according to either one of Ex22 or Ex23, wherein the first and second legs are equal in length and arranged in side-by-side, non-overlapping relationship.

Example Ex25: The susceptor assembly according to any one of Ex22 to Ex24, wherein the wicking element is folded about a fold line to define a first planar layer overlying a second planar layer, the first layer extending from the fold line to a side face of the first layer, the second layer extending from the fold line to a side face of the second layer, the side faces of the first and second layers aligned with each other to form a common side face, the first and second legs extending in opposite directions to wrap around the common side face.

Example Ex26: The susceptor assembly according to Ex25, wherein the first and second legs wrap around the common side face such that opposing surfaces of the first and second planar layers of the wicking element are urged into surface contact with each other.

Example Ex27: The susceptor assembly according to any one of Ex1 to Ex6, wherein the susceptor element comprises an arrangement of a plurality of strips.

Example Ex28: The susceptor assembly according to Ex27, wherein the susceptor element comprises an arrangement of a first strip and a second strip, each of the first and second strips extending over a length between first and second ends, the first strip extending along the first planar, outward-facing surface of the wicking element; and the second strip extending along the second planar, outward-facing surface of the wicking element.

Example Ex29: The susceptor assembly according to Ex28, wherein the first ends of the first and second strips are positioned to extend in opposite directions towards each other along a first side face of the wicking element, and the second ends of the first and second strips are positioned to extend in opposite directions towards each other along a second side face of the wicking element, each of the first and second side faces extending between the first and second planar outward-facing surfaces of the wicking element.

Example Ex30: The susceptor assembly according to Ex29, wherein the wicking element has a thickness defined by the first and second sides faces of the wicking element.

Example Ex31: The susceptor assembly according to either one of Ex29 or Ex30, wherein the first and second ends of the first and second strips are folded ends.

Example Ex32: The susceptor assembly according to any one of Ex29 to Ex31, wherein one or both of the following conditions apply:
a) the first ends of the first and second strips are separated from each other by a gap along the first side face of the wicking element;
b) the second ends of the first and second strips are separated from each other by a gap along the second side face of the wicking element.

Example Ex33: The susceptor assembly according to any one of Ex29 to Ex31, wherein one or both of the following conditions apply:
a) the first ends of the first and second strips are in surface contact, overlie or intermesh with each other or a combination thereof;
b) the second ends of the first and second strips are in surface contact, overlie or intermesh with each other or a combination thereof.

Example Ex34: The susceptor assembly according to any one of claims Ex29 to Ex31, or Ex33, wherein the wicking element comprises a first planar layer overlying a second planar layer, wherein at least one of the first and second ends of the first strip is folded inwardly to wrap around a side face of the first layer to tuck between the first and second layer, and at least one of the first and second ends of the second strip is folded inwardly to wrap around a side face of the second layer to tuck between the first and second layers.

Example Ex35: The susceptor assembly according to Ex34, wherein the respective side faces of the first and second planar layers are aligned with each other.

Example Ex36: The susceptor assembly according to either one of Ex34 or Ex35, wherein the tucked-in ends of the first and second strips are arranged to maintain a clearance between opposing surfaces of the first and second planar layers of the wicking element.

Example Ex37: The susceptor assembly according to any one of Ex34 to Ex36, wherein the wicking element is folded about a fold line, in which the first planar layer of the wicking element extends from the fold line to the side face of the first layer and the second planar layer of the wicking material extends from the fold line to the side face of the second layer.

Example Ex38: The susceptor assembly according to any one of Ex34 to Ex37, wherein the first layer is aligned parallel to the second layer.

Example Ex39: The susceptor assembly according to either one of Ex29 or Ex30, wherein one or both of the following conditions apply:
a) the first end of each of the first and second strips comprises a first leg, the first legs of the first and second strips laterally offset from each other and extending in opposite directions from adjoining portions of the respective strip to wrap around the first side face of the wicking element;
b) the second end of each of the first and second strips comprises a second leg, the second legs of the first and second strips laterally offset from each other and extending in opposite directions from adjoining portions of the respective strip to wrap around the second side face of the wicking element.

Example Ex40: The susceptor assembly according to Ex39, wherein one of both of the following conditions apply:
a) the first legs of the first and second strips are of reduced lateral width relative to the adjoining portion of the respective strip;
b) the second legs of the first and second strips are of reduced lateral width relative to the adjoining portion of the respective strip.

Example Ex41: The susceptor assembly according to either one of Ex39 or Ex40, wherein one of both of the following conditions apply:
a) the first legs of the first and second strips are equal in length and arranged in side by side, non-overlapping relationship;
b) the second legs of the first and second strips are equal in length and arranged in side by side, non-overlapping relationship.

Example Ex42: The susceptor assembly according to any one of Ex39 to Ex41, wherein the wicking element is folded about a fold line to define a first planar layer overlying a second planar layer, the first layer extending from the fold line to a side face of the first layer, the second layer extending from the fold line to a side face of the second layer, the side faces of the first and second layers aligned with each other to form a common side face, the first legs extending in opposite directions to wrap around the common side face.

Example Ex43: The susceptor assembly according to Ex42, wherein the first legs wrap around the common side face such that opposing surfaces of the first and second planar layers of the wicking element are urged into surface contact with each other.

Example Ex44: The susceptor assembly according to any one of Ex1 to Ex43, comprising a pair of unwrapped portions of the wicking element extending laterally outward from opposite sides of the wrapped central region of the wicking element.

Example Ex45: The susceptor assembly according to Ex44, wherein the pair of unwrapped portions is configured for engaging with a pair of corresponding openings provided on opposing sides of an air flow channel.

Example Ex46: A cartridge for coupling to an aerosol-generating device, the cartridge comprising the susceptor assembly according to any one of Ex1 to Ex45, wherein the cartridge comprises an internally positioned air flow channel and a reservoir for liquid aerosol-forming substrate, the cartridge configured to receive the susceptor assembly such that the susceptor element is positioned in the air flow channel with the reservoir in fluid communication with the wicking element of the susceptor assembly.

Example Ex47: The cartridge according to Ex46, wherein the susceptor assembly comprises a pair of unwrapped portions of the wicking element extending laterally outward from opposite sides of the wrapped central region of the wicking element, the cartridge comprising a pair of openings positioned on opposing sides of the air flow channel, the pair of unwrapped portions of the wicking element received in the pair of openings.

Example Ex48: The cartridge of either one of Ex46 or Ex47, wherein the cartridge comprises a detachable holder, the holder at least partially defining the air flow channel, the holder configured to receive the susceptor assembly such that the susceptor element is positioned in the air flow channel.

Example Ex49: An aerosol-generating system comprising an aerosol-generating device and a cartridge according to any one of Ex46 to Ex49, the aerosol-generating device comprising an inductor that at least in part surrounds the susceptor element when the cartridge is coupled to the aerosol-generating device.

### Example Ex49a: an Aerosol-generating System According to Ex49, in Which the

inductor is or comprises a helical coil.

Example Ex50: A method of manufacturing a susceptor assembly comprising steps of:
providing a wicking element having first and second planar surfaces, the first and second planar surfaces defining opposite, outward-facing surfaces of the wicking element;
providing one or more strips of susceptor material;
wrapping the one or more strips around a central region of the wicking element to form an arrangement of the one or more strips overlying the first and second outward-facing surfaces of the wicking element and enclosing the central region of the wicking element.

Example Ex51: The method according to Ex50, wherein the step of wrapping the one or more strips around a central region of the wicking element comprises performing a series of folding operations on the one or more strips.

Example Ex52: The method according to either one of Ex50 or Ex51, wherein the step of wrapping the one or more strips around a central region of the wicking element is performed such that the one or more strips compress the central region of the wicking element.

Example Ex53: A method of manufacturing a susceptor assembly comprising steps of:
providing a sheet of wicking material;
providing one or more strips of susceptor material;
wrapping the one or more strips together with the sheet of wicking material to fold a first portion of the sheet of wicking material over a second portion of the sheet of wicking material to form a wicking element from the sheet of wicking material, wherein the one or more strips are wrapped around a central region of the wicking element to form an arrangement of the one or more strips overlying first and second outward-facing surfaces of the wicking element and enclosing the central region of the wicking element.

Example Ex54: The method according to Ex53, wherein wrapping the one or more strips around a central region of the wicking element comprises performing a series of folding operations on the one or more strips.

Example Ex55: The method according to either one of Ex53 or Ex54, wherein wrapping the one or more strips around a central region of the wicking element is performed such that the one or more strips compress the central region of the wicking element.

Examples will now be further described with reference to the figures in which:

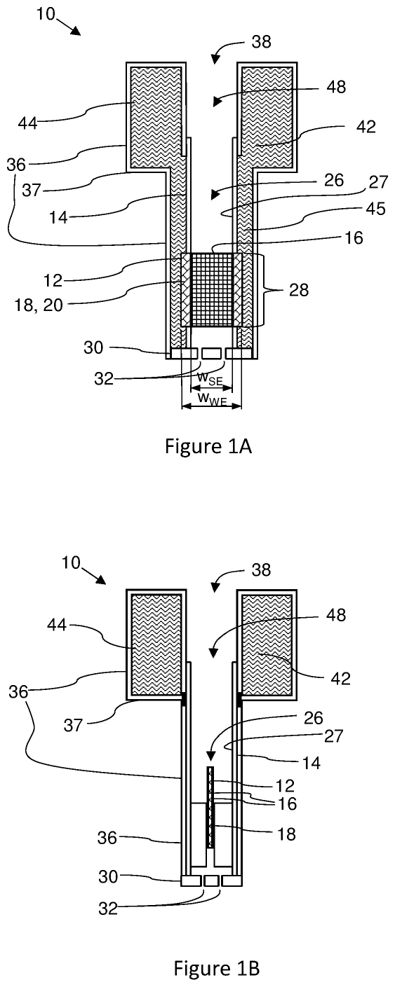

FIG. 1A shows a schematic illustration of a cross-section of a cartridge for an aerosol-generating system, the cartridge comprising a heater holder.

FIG. 1B shows a schematic illustration of an alternative cross-section of the cartridge of FIG. 1A.

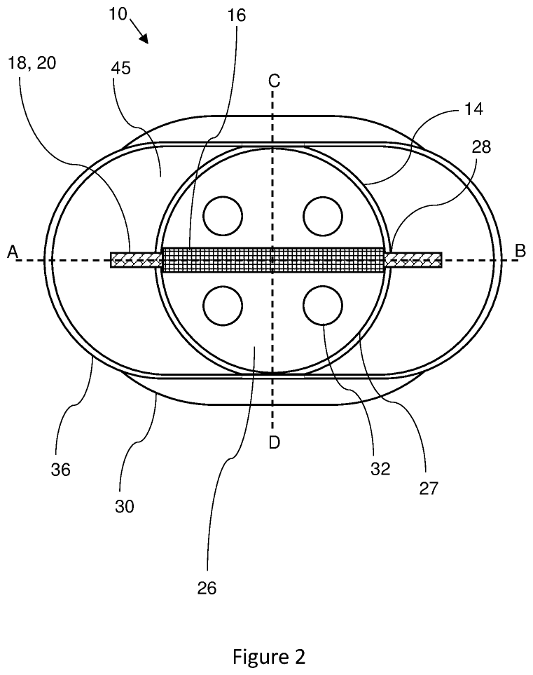

FIG. 2 shows a schematic illustration of a further alternative cross-section of the cartridge of FIGS. 1A and 1B.

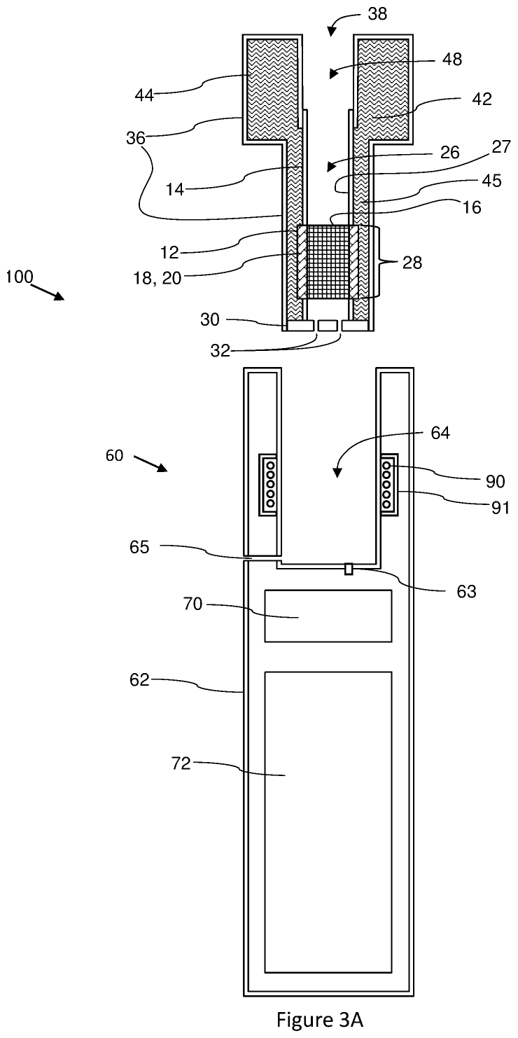

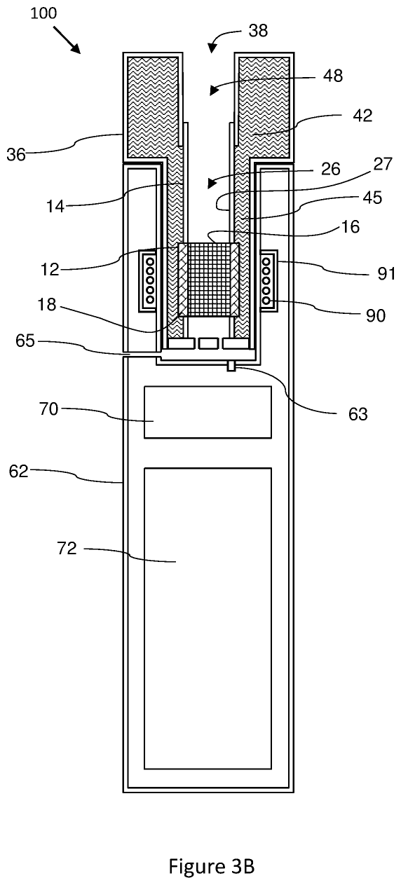

FIG. 3A shows a schematic illustration of a cross-section of an aerosol-generating system formed of a cartridge and an aerosol-generating device, in which the cartridge is decoupled from the aerosol generating device.

FIG. 3B shows a schematic illustration of a cross-section of the aerosol-generating system of FIG. 3A, in which the cartridge is coupled to the aerosol generating device.

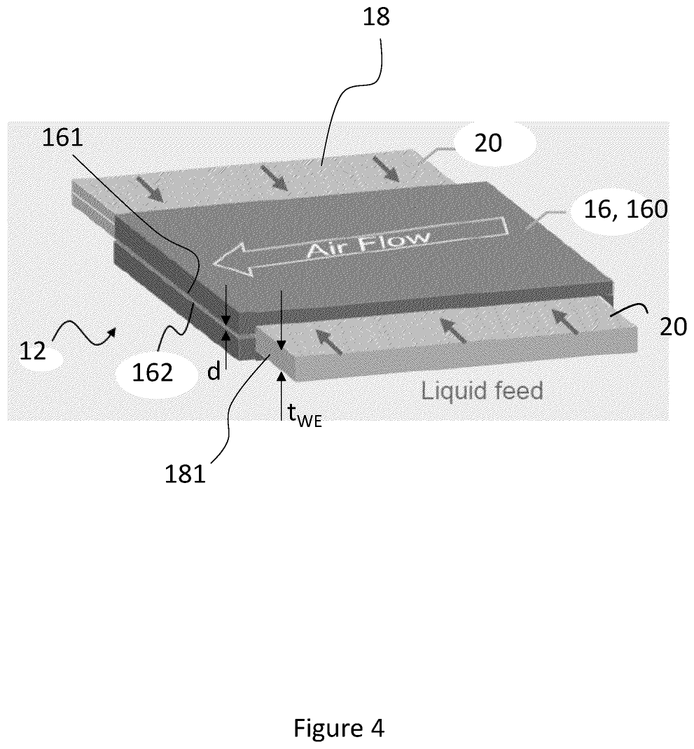

FIG. 4 shows a schematic perspective illustration of an embodiment of a susceptor assembly according to the present disclosure, in which a susceptor element strip is wrapped around a wicking element.

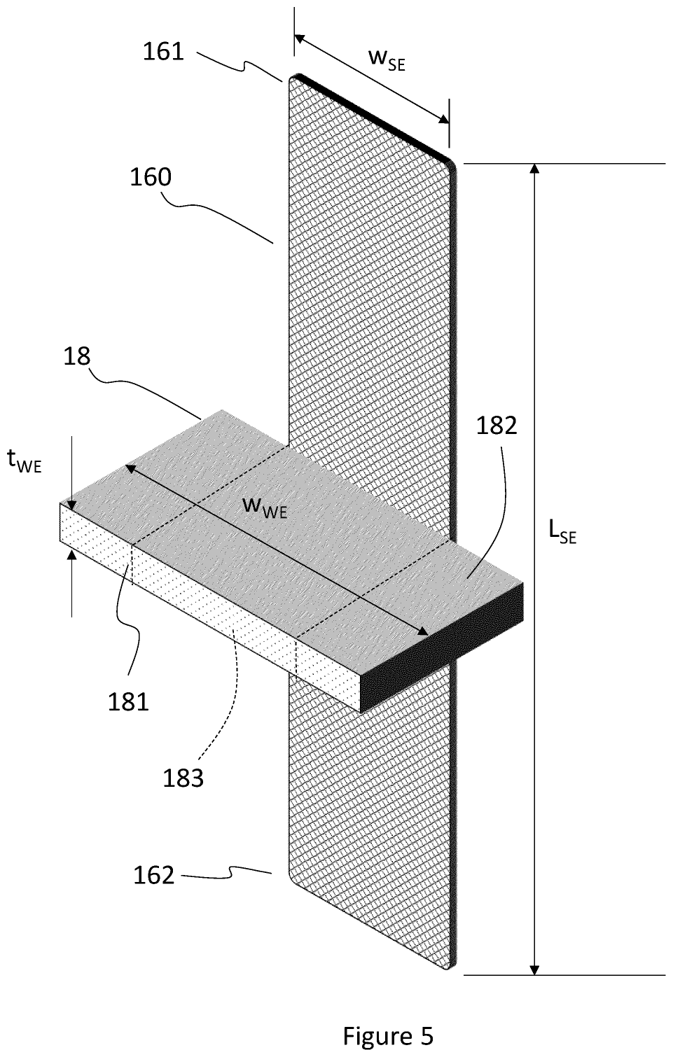

FIG. 5 shows a schematic perspective illustration of the susceptor element strip and wicking element of the susceptor assembly of FIG. 4 prior to the strip being wrapped around the wicking element.

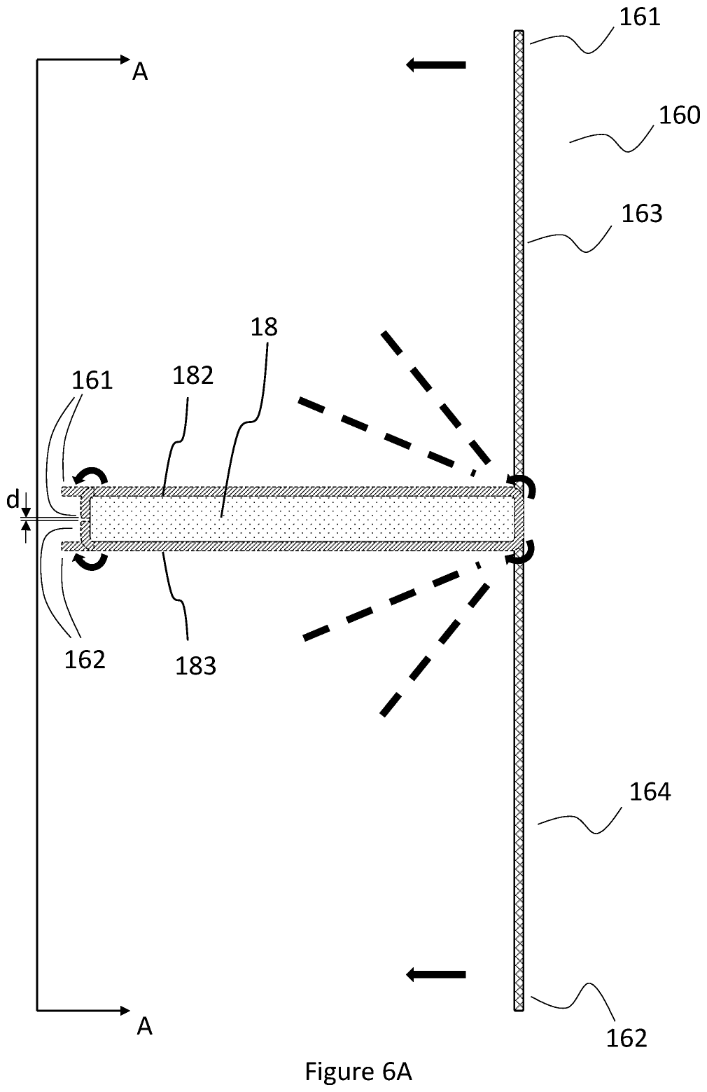

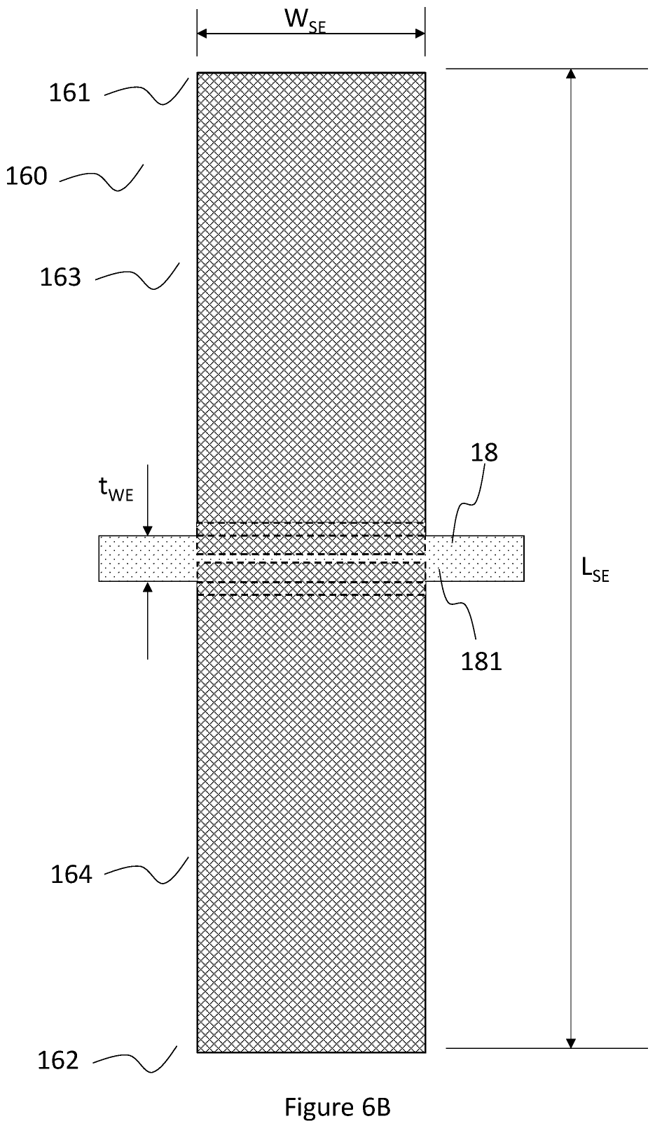

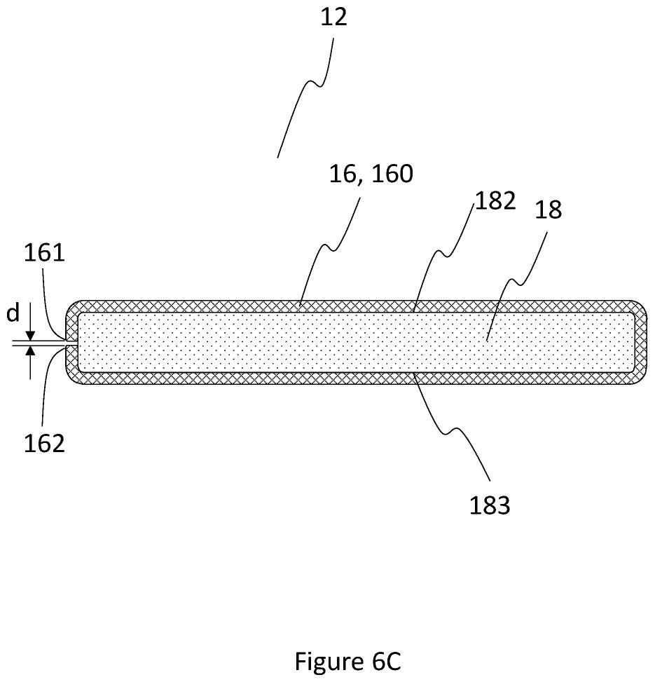

FIG. 6A shows a schematic side elevation view of an embodiment illustrating how a susceptor element strip is progressively wrapped around a wicking element by one or more folding operations to form a susceptor assembly.

FIG. 6B shows a schematic side elevation view along section A-A of FIG. 6A, again illustrating how the susceptor element strip is progressively wrapped around the wicking element to form the susceptor assembly.

FIG. 6C shows a schematic side elevation view showing an embodiment of the susceptor assembly resulting from the susceptor element strip being wrapped around the wicking element by the one or more folding operations indicated in FIG. 6A, resulting in first and second ends of the strip being opposed from each other along a side face of the wicking element.

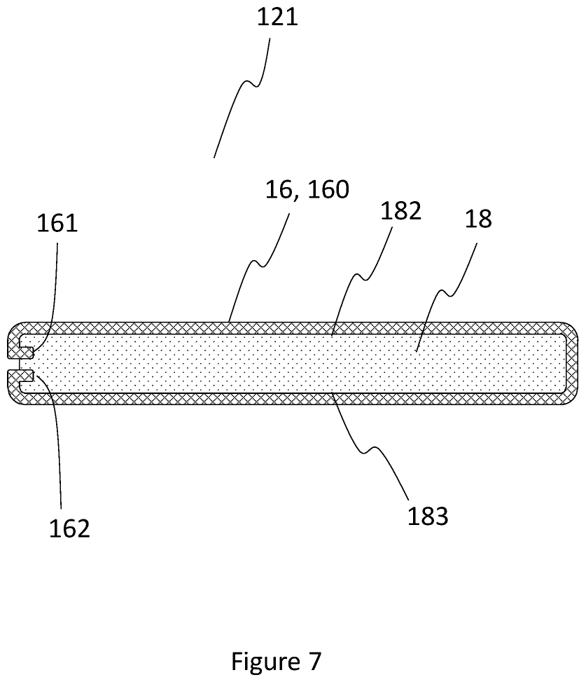

FIG. 7 shows a schematic side elevation view of an alternative embodiment of a susceptor assembly resulting from the susceptor element strip being wrapped around the wicking element, in which one or more additional folding operations are performed relative to those illustrated in FIG. 6A, such that the first and second ends of the strip are embedded in the side face of the wicking element.

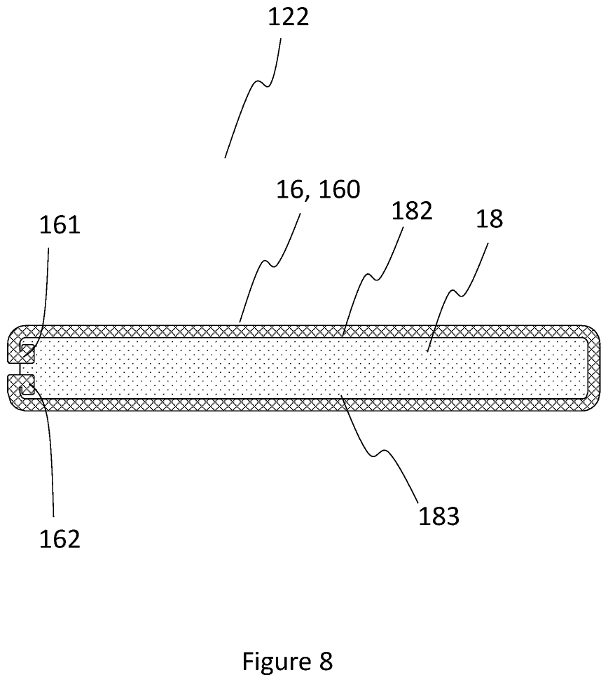

FIG. 8 shows a schematic side elevation view of a further alternative embodiment of a susceptor assembly resulting from the susceptor element strip being wrapped around the wicking element, in which one or more additional folding operations are performed relative to those illustrated in FIG. 6A, such that the first and second ends of the strip are folded inwardly back over the strip to overlie an inward-facing surface of the strip;

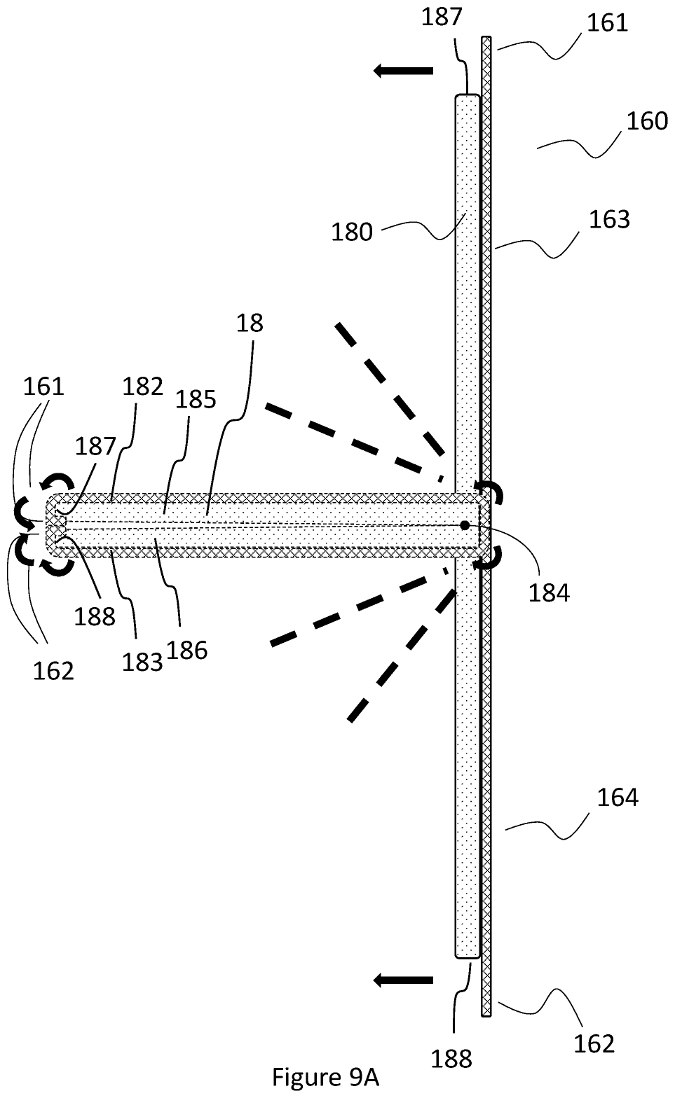

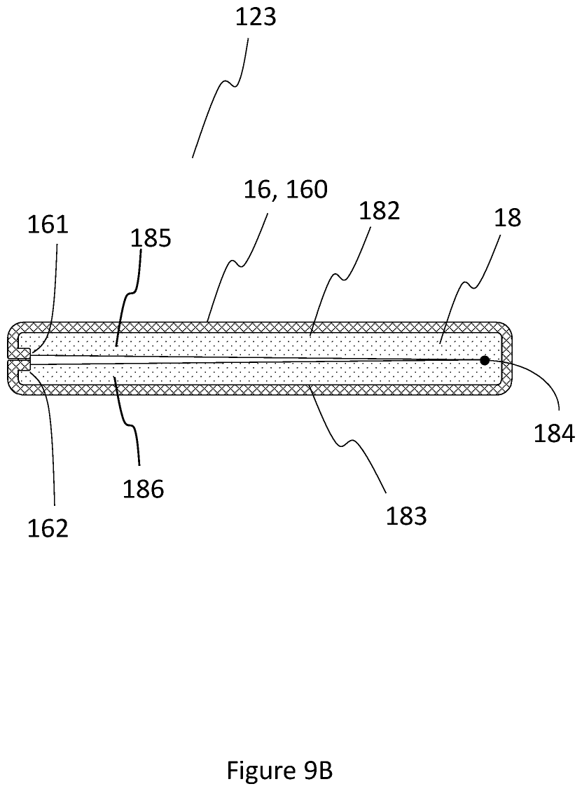

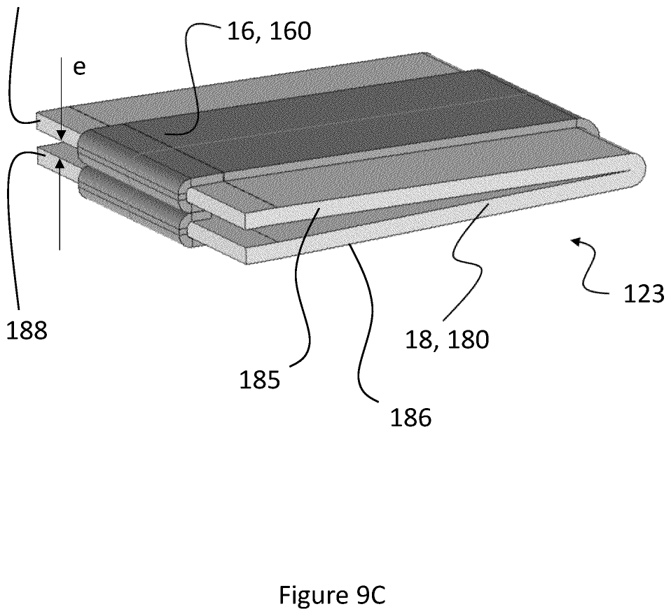

FIG. 9A shows a schematic side elevation view of an embodiment in which a susceptor element strip is progressively folded around a sheet of wicking material so that the wicking material is folded about a fold line to form a wicking element having a first planar layer overlying a second planar layer, with the strip wrapped around the wicking element such that first and second ends of the strip wrap around respective side faces of the first and second layers to tuck between the first and second layers.

FIG. 9B shows a schematic side elevation view of an embodiment of a susceptor assembly resulting from a susceptor element strip being progressively folded around a sheet of wicking material by the one or more folding operations indicated in FIG. 9A.

FIG. 9C shows a schematic perspective illustration of the susceptor assembly of FIG. 9B.

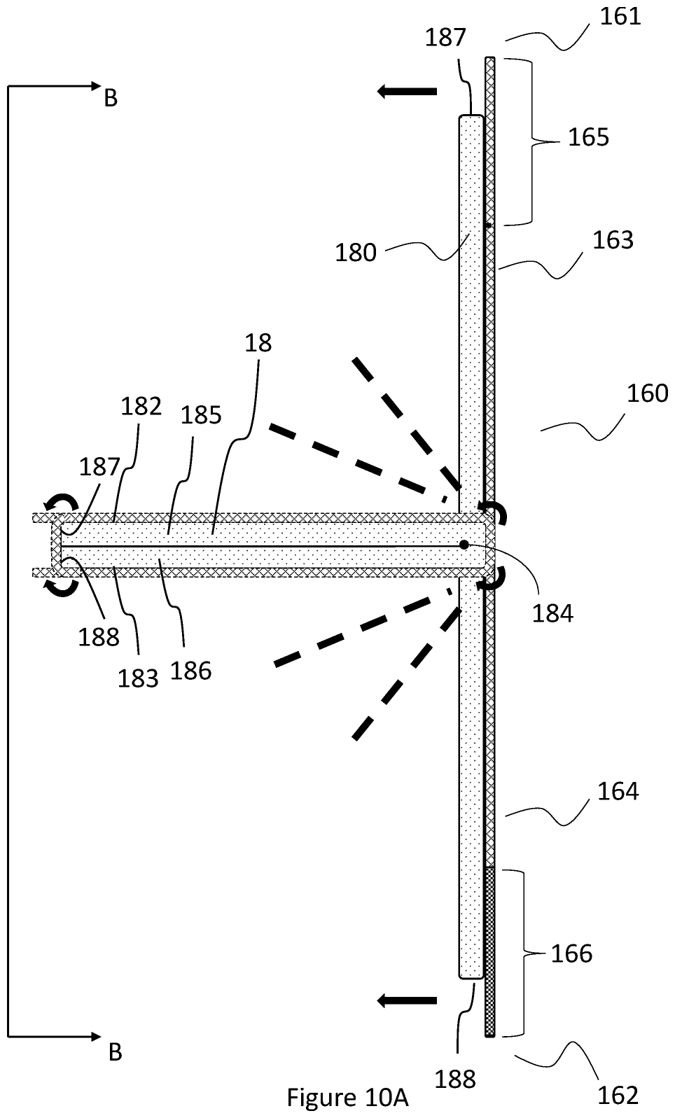

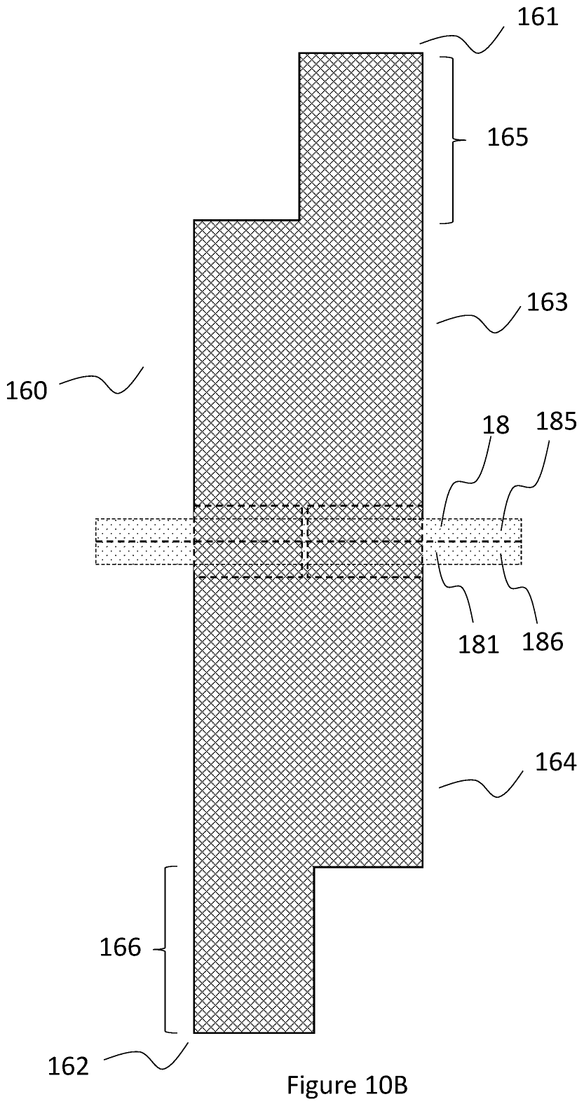

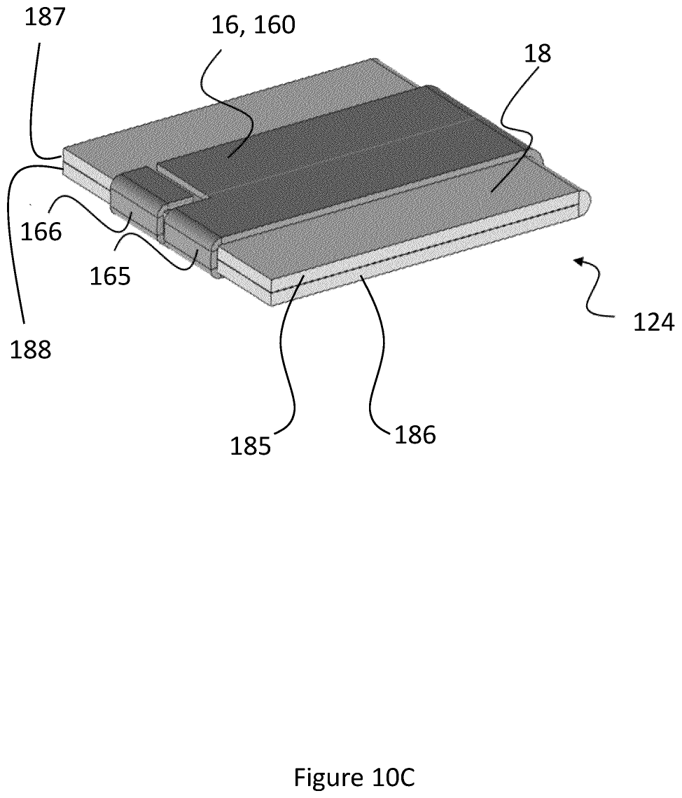

FIG. 10A shows a schematic side elevation view of an embodiment in which a susceptor element strip is progressively folded around a sheet of wicking material so that the wicking material is folded about a fold line to form a wicking element having a first planar layer overlying a second planar layer, in which first and second ends of the strip each have corresponding legs laterally offset from each other.

FIG. 10B shows a schematic side elevation view along section B-B of FIG. 10A, illustrating the laterally offset legs provided on first and second ends of the susceptor element strip.

FIG. 10C shows a schematic perspective illustration of the susceptor assembly resulting from the folding operations illustrated in FIG. 10A.

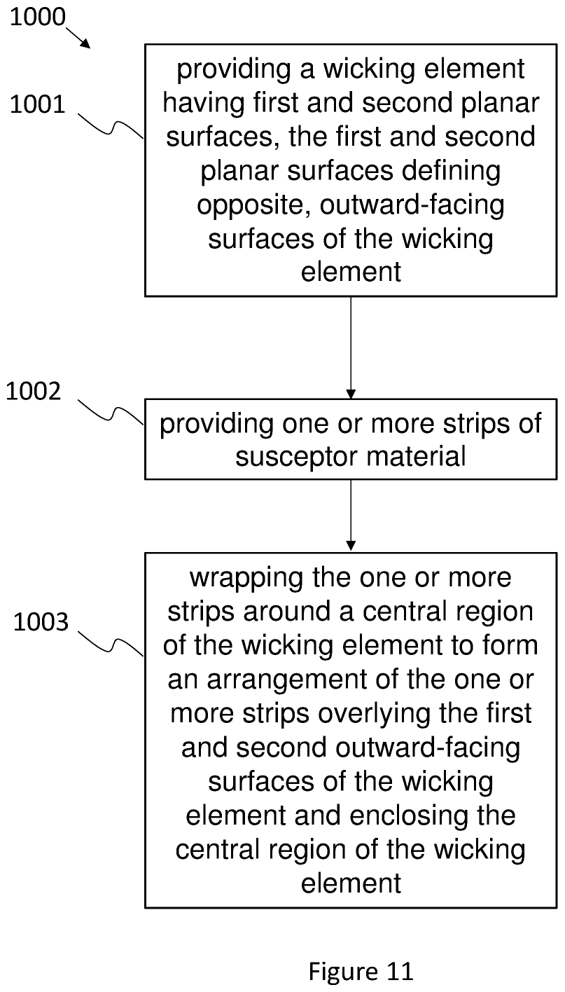

FIG. 11 shows steps of a first exemplary method of manufacturing a susceptor assembly according to the present disclosure.

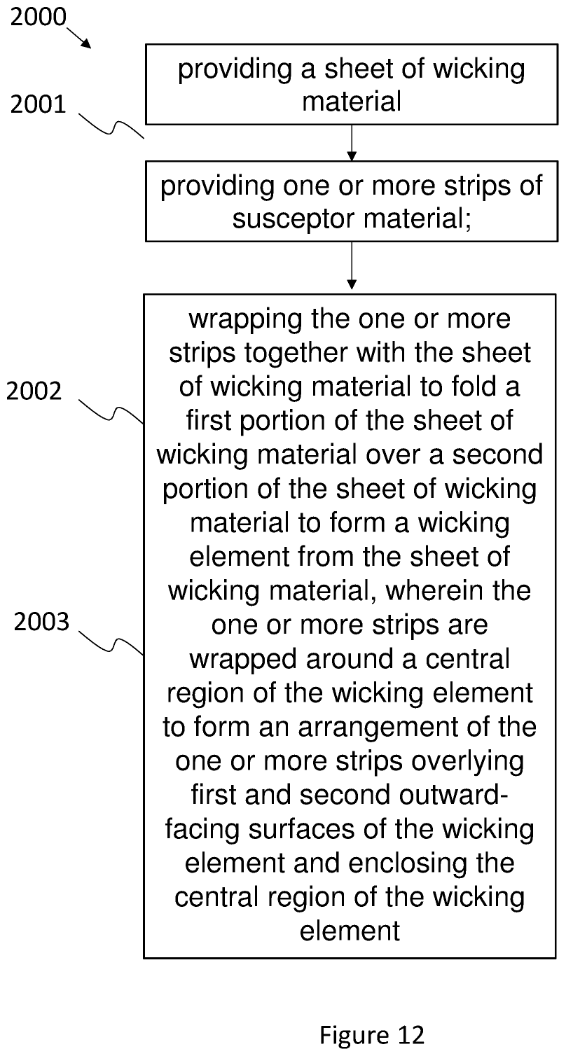

FIG. 12 shows steps of a second exemplary method of manufacturing a susceptor assembly according to the present disclosure.

FIGS. 1A and 1B show schematic illustrations of two cross sections of a cartridge 10 for an aerosol-generating system, the cartridge 10 being according to a first embodiment of the present disclosure. The two cross sections are taken in two planes perpendicular to one another.

FIG. 1 shows the cartridge 10 comprising a heater holder 14 and a heater assembly 12 mounted in the heater holder 14. The heater assembly 12 is planar, and thin, having a thickness dimension that is substantially smaller than a length dimension and a width dimension. The heater assembly 12 is shaped in the form of a rectangle, and comprises a susceptor element 16 wrapped around a wicking element 18. The width WSE of the susceptor element 16 is smaller than the width w_{WE} of the wicking element 18, with the susceptor element 16 wrapped around a central region of the wicking element 18 to define outer, exposed portions 20 of the wicking element 18 which are not enclosed by the susceptor element 16. The outer, exposed portions 20 of the wicking element 18 protrude through a pair of openings 28 arranged on opposed sides of an internal side wall 27 of the heater holder 14, into one of two channels 45. The internal side wall 27 defines an internal passage 26 of the heater holder 14. The susceptor element 16 comprises a sintered mesh formed from ferritic stainless steel filaments and austenitic stainless steel filaments. The wicking element 18 comprises a porous body of rayon filaments. The wicking element 18 is configured to deliver liquid via the outer, exposed portions 20 of the wicking element 18 to the susceptor element 16.

As the heater assembly 12 employs susceptor element 16, the heater assembly 12 is referred from this point forwards as being susceptor assembly 12.

The susceptor element 16 is configured to be heatable by penetration with an alternating magnetic field, for vaporising an aerosol-forming substrate. The outer, exposed portions 20 of the wicking element 18 protrude through the pair of openings 28 in the heater holder 14, such that the heater holder 14 supports the heater assembly 12 in position in the cartridge 10.

The susceptor assembly 12 is partially arranged inside the internal passage 26 of the tubular heater holder 14, and extends in a plane parallel to a central longitudinal axis of the heater holder 14. The susceptor element 16 is arranged entirely within the internal passage 26 of the heater holder 14 and the outer, exposed portions 20 of the wicking element 18 extend through the pair of openings 28 in the internal side wall 27 of the heater holder 14 into the two channels 45. The outer, exposed portions 20 of the wicking element 18 define mounting regions 20 of the susceptor assembly 12 for mounting the susceptor assembly in the heater holder 14.

The cartridge 10 has a mouth end and a connection end opposite to the mouth end. An outer housing 36 defines a mouth end opening 38 at the mouth end of the cartridge 10. The connection end is configured for connection of the cartridge 10 to an aerosol-generating device, as described in detail below. The susceptor assembly 12 and the heater holder 14 are located towards the connection end of the cartridge 10.

The outer housing 36 is formed from a mouldable plastics material, such as polypropylene. The outer housing 36 defines an internal space in which the susceptor assembly 12 and the heater holder 14 are contained.

The external width of the outer housing 36 is greater at the mouth end of the cartridge 10 than at the connection end, which are joined by a shoulder 37. This enables the connection end of the cartridge 10 to be received in a cavity of an aerosol-generating device, with the shoulder 37 locating the cartridge in the correct position in the device. This also enables the mouth end of the cartridge 10 to remain outside of the aerosol-generating device, with the mouth end conforming to the external shape of the aerosol-generating device.

The cartridge 10 further comprises a liquid reservoir 44. The liquid reservoir 44 is defined in the cartridge 10 for holding a liquid aerosol-forming substrate 42.

The liquid reservoir 44 extends from the mouth end of the outer housing 36 to the connection end of the outer housing 36, and comprises an annular space defined by the outer housing 36 and an internal side wall of the cartridge 10.

The internal side wall of the cartridge 10 defines an internal passage 48 that extends between the mouth end opening 38, and an open end of the internal passage 26 of the heater holder 14.

The liquid reservoir 44 further comprises the two channels 45, the two channels 45 being defined between the outer housing 36 at the connection end and the internal side wall 27 defining the internal passage 26 of the heater holder 14. The two channels 45 extend from the annular space defined by the outer housing 36 and the internal side wall of the cartridge 10 at the mouth end of the cartridge 10, to the connection end of the cartridge 10. The outer, exposed portions 20 of the wicking element 18 extend through the openings 28 in the internal side wall 27 of the heater holder 14 into the two channels 45. The two channels 45 extend from the annular space defined by the outer housing 36 and the internal side wall of the cartridge 10 at the mouth end of the cartridge 10, on opposite sides of the internal passage 26 of the heater holder 14.

The heater holder 14 comprises a base 30 that partially closes one end of the internal passage 26. The base 30 comprises a plurality of air inlets 32 that enable air to be drawn into the internal passage 26 through the partially closed end.

An air passage is formed through the cartridge 10 by the internal passage 26 of the heater holder 14, and internal passage 48. The air passage extends from the air inlets 32 in the base 30 of the heater holder 14, through the internal passage 26 of the heater holder 14, and through the internal passage 48 to the mouth end opening 38. The air passage enables air to be drawn through the cartridge 10 from the connection end to the mouth end.

FIG. 2 shows a schematic illustration of a further alternative cross section of the cartridge 10 of FIGS. 1A and 1B. The cartridge 10 is viewed perpendicular to the views shown in FIGS. 1A and 1B, such that the cross section shown in FIG. 1A is indicated by the dashed line AB, and the cross section shown in FIG. 1B is indicated by the dashed line CD.

The cartridge 10 comprises heater holder 14. The heater holder 14 comprises a tubular body formed from a mouldable plastic material, such as polypropylene. The tubular body of the heater holder 14 comprises the internal side wall 27 defining the internal passage 26 having open ends. The pair of openings 28 extend through the internal side wall 27, at opposite sides of the tubular heater holder 14. The openings 28 are arranged centrally along the length of the heater holder 14.

The pair of openings 28 in the side wall 27 of the heater holder 14 are sized to accommodate the susceptor assembly 12 with a friction fit, such that the susceptor assembly is secured in the heater holder 14. The friction fit between the susceptor assembly 12 and the heater holder 14 results in the mounting regions 20 directly contacting the heater holder 14 at the openings 28. The susceptor assembly 12 and the heater holder 14 are secured together such that movement of the heater holder 14 also moves the susceptor assembly 12.

It will be appreciated that the susceptor assembly 12 and the heater holder 14 may be secured together by other means. For example, in some embodiments the susceptor assembly 12 is secured to the heater holder 14 by an adhesive at the mounting regions 20 of the susceptor assembly 12, such that the mounting regions 20 indirectly contact the heater holder 14.

The two channels 45 are positioned on opposite sides of the internal passage 26, and in use the two channels 45 supply liquid aerosol-forming substrate to the heater assembly 12. The outer, exposed portions of the wicking element 18 which form the mounting regions 20 of the susceptor assembly 12 extend out of the internal passage 26 into the channels 45 via the openings 28. The channels 45 are shown empty in FIG. 2, but can be understood to be filled with liquid aerosol-forming substrate prior to use.

The cartridge 10 is viewed in FIG. 2 from the mouth end towards the connection end. The plurality of air inlets 32 in the base 30 can therefore be seen in FIG. 2.

FIG. 3A shows a schematic illustration of a cross-section of an aerosol-generating system 100 according to the present disclosure, with cartridge 10 decoupled from an aerosol generating device 60.

The cartridge 10 is identical to that presented in FIGS. 1A, 1B and 2, and their corresponding descriptions.

The aerosol-generating device 60 comprises a generally cylindrical device outer housing 62 having a connection end and a distal end opposite the connection end. A cavity 64 for receiving the connection end of the cartridge 10 is located at the connection end of the device 60, and an air inlet 65 is provided through the device outer housing 62 at the base of the cavity 64 to enable ambient air to be drawn into the cavity 64.

The device 60 further comprises an inductive heating arrangement arranged within the device outer housing 62. The inductive heating arrangement includes an inductor coil 90, control circuitry 70 and a power supply 72. The power supply 72 comprises a rechargeable nickel cadmium battery or a lithium ion battery, which is rechargeable via an electrical connector (not shown) at the distal end of the device. The control circuitry 70 is connected to the power supply 72, and to the inductor coil 90, such that the control circuitry 70 controls the supply of power to the inductor coil 90. The control circuitry 70 is configured to supply an alternating current to the inductor coil 90.

The single inductor coil 90 is positioned around the susceptor assembly 12 when the cartridge 10 is received in the cavity 64. The inductor coil 90 has a size and a shape matching the size and shape of the susceptor element 16. The inductor coil 90 is made with a copper wire having a round circular section, and is arranged on a coil former element (not shown). The inductor coil 90 is both tubular and helical, and defines a circular cross section when viewed along the longitudinal axis of the aerosol-generating device.

The inductor coil 90 is configured such that when the alternating current is supplied to the inductor coil, the inductor coil generates an alternating magnetic field in the region of the susceptor assembly 12 when the cartridge 10 is received in the cavity 64.

The inductive heating arrangement further includes a flux concentrator element 91. The flux concentrator element 91 has a greater radius than the inductor coil 90, and so partially surrounds the inductor coil 90. The flux concentrator element 91 is configured to reduce stray power losses from the generated magnetic field.

FIG. 3B shows a schematic illustration of a cross section of the aerosol-generating system 100 of FIG. 3A, but with the cartridge 10 coupled to the aerosol-generating device 60.

In operation, when a user puffs on the mouth end opening 38 of the cartridge 10, ambient air is drawn into the base of the cavity 64 through air inlet 65, and into the cartridge 10 through the air inlets 32 in the base 30 of the cartridge 10. The ambient air flows through the cartridge 10 from the base 30 to the mouth end opening 38, through the air passage defined by internal passage 26 and over the susceptor assembly 12.

The control circuitry 70 controls the supply of electrical power from the power supply 72 to the inductor coil 90 when the system is activated.

The control circuitry 72 is coupled to an airflow sensor 63. The airflow sensor 63 is in fluid communication with the passage of ambient air which is drawn through the system by the user. The control circuitry 72 supplies electrical power to the inductor coil 90 when user-applied puffs on the cartridge 10 are detected by the airflow sensor 63.

When the system 100 is activated, an alternating current is established in the inductor coil 90, which generates alternating magnetic fields in the cavity 64 in which the susceptor assembly 12 is located, causing the susceptor element 16 to heat. Liquid aerosol-forming substrate in the channels 45 is drawn into the susceptor assembly 12 through the wicking element 18 towards the susceptor element 16. The liquid aerosol-forming substrate 42 at the susceptor element 16 is heated, and volatile compounds from the heated aerosol-forming substrate are released into the air passage defined by the internal passage 48 of the cartridge 10, and cool to form an aerosol. The aerosol is entrained in the air being drawn through the internal passage 48 of the cartridge 10, and is drawn out of the cartridge 10 at the mouth end opening 38 for inhalation by the user.

FIG. 4 shows a perspective view of an embodiment of a susceptor assembly 12 suitable for use in the cartridge 10 of FIGS. 1A, 1B and 2 and as part of the aerosol-generating system 100 of FIGS. 3A and 3B. The susceptor assembly 12 has a susceptor element 16 defined by a single strip 160 of susceptor material wrapped around a central region of the wicking element 18. The strip of susceptor material 160 overlies opposing upper and lower planar surfaces of the wicking element 18, as well as opposing side faces of the wicking element 18. First and second ends 161, 162 of the strip 160 extend towards each other from opposite directions along a downstream side face 181 of the wicking element 18. The wicking element 18 has a uniform thickness t_{WE} defined by the side face 181 of the wicking element. For the embodiment shown in FIG. 4, free edges of the first and second ends 161, 162 of the strip 160 oppose each other along the downstream side face 181 of the wicking element 18, being separated by a gap ‘d’. In this manner, the susceptor element 16 defined by the strip 160 of susceptor material encloses the central region of the wicking element 18. The width w_{SE} of the susceptor element 16 formed by strip 160 is less than the width w_{WE} of the wicking element 18, leaving the outer, exposed portions 20 of the wicking element 18 extending laterally outward from the central region of the wicking element 18 which is wrapped and enclosed by the susceptor element 16. As noted above, these outer, exposed portions 20 of the wicking element 18 serve as mounting regions by which the susceptor assembly 12 may be held in the heater holder 14 of the cartridge 10 (see FIGS. 1A, 1B and 2). FIG. 4 includes arrows representing the passage of air flow over the susceptor element 16 between upstream and downstream directions, and the flow of liquid aerosol-forming substrate through the wicking element 18 via the laterally opposed, exposed portions 20 of the wicking element 18.

FIG. 5 shows a perspective schematic illustration of the susceptor element strip 160 and wicking element 18 prior to the strip 160 being wrapped around a central region of the wicking element 18. The lateral extent of the central region of the wicking element 18 overlaid by the strip 160 is generally indicated by the broken lines on upper outward-facing surface 182 of the wicking element 18 in FIG. 5. The strip 160 of susceptor material has a length L_{SE} of around 14.3 cm and a width w_{SE} of around 2.8 cm. However, the dimensions of the strip 160 may be varied according to factors such as the size of the cartridge 10 of which the susceptor assembly 12 is intended to form part, and the size of the inductor coil 90 of the aerosol-generating device 60. It will be understood that the strip 160 of susceptor material may be cut or stamped out from a larger sheet of material to form a plurality of susceptor element strips, such as individual strip 160.

As shown in FIGS. 5 and 6A, the strip 160 of susceptor material is initially located against one of the side faces of the wicking element 18. The strip 160 is then subjected to a series of folding operations (represented by the arrows in FIG. 6A). A first of these folding operations folds upper portion 163 of the strip 160 over upper outward-facing surface 182 of the wicking element 18 and folds lower portion 164 of the strip 160 over lower outward-facing surface 183 of the wicking element 18. After this first folding operation, the first and second ends 161, 162 of the strip 160 extend parallel to and away from the surfaces 182, 183 of the wicking element 18 (shown in broken outline in FIG. 6A). In one or more subsequent folding operations, the first and second ends 161, 162 of the strip 160 are folded over an edge of the wicking element 18 to lie against the downstream side face 181 of the wicking element 18. In the embodiment shown in FIG. 6A, the free edges of the first and second ends 161, 162 of the strip 160 oppose each other along the downstream side face 181 of the wicking element 18 and are separated by gap ‘d’. It will be appreciated that in other embodiments, the free edges of the first and second ends 161, 162 of the strip 160 may be arranged in end-to-end relationship, or the first and second ends 161, 162 may overlap each other. Where the first and second ends 161, 162 overlap with each other, it may be preferred that the overlap is confined to a side face (for example, side face 181) of the wicking element 18 so as to avoid unduly obstructing air flow through the internal passage 26 of the heater holder 14 in use. FIG. 6B provides a view of the strip 160 of susceptor material and wicking element 18 along section A-A of FIG. 6A. In FIGS. 6A and 6B, the strip 160 of susceptor material prior to being folded around the wicking element 18 is shown with a solid, unbroken outline, whereas the strip 160 after performing different ones of the folding operations is shown in broken outline. FIG. 6C shows a side elevation view of the susceptor assembly 12 resulting from the strip 160 of susceptor material having been wrapped around the central region of the wicking element 18 to form susceptor element 16.

FIG. 7 illustrates an alternative embodiment of susceptor assembly 121 to that of FIGS. 6A-C, resulting from first and second ends 161, 162 of the strip 160 of susceptor material undergoing a further folding operation to embed within the side face 181 of the wicking element 18 to form susceptor element 16.

FIG. 8 illustrates a further alternative embodiment of susceptor assembly 122, resulting from first and second ends 161, 162 of the strip 160 undergoing a further folding operation to fold each of the first and second ends 161, 162 back over an inward-facing surface of the strip to form susceptor element 16. In this manner, the first and second ends 161, 162 of the strip define folded ends, with the free edge of each of the first and second ends 161, 162 hidden from view.

FIG. 9A shows a further alternative embodiment, in which a strip 160 of susceptor material is initially located adjacent a corresponding sheet 180 of wicking material. A series of folding operations are then performed (represented by the arrows in FIG. 9A). In a first one of the folding operations, the strip 160 of susceptor material and the sheet 180 of wicking material are folded together such that the sheet 180 of wicking material folds about a fold line 184 (extending into and out from the page in FIG. 9A) to form a wicking element 18 having a first planar layer 185 overlying a second planar layer 186. After this first folding operation, the first and second ends 161, 162 of the strip extend parallel to and away from upper and lower outward-facing surfaces 182, 183 of the wicking element. In one or more subsequent folding operations, the first and second ends 161, 162 of the strip 160 are folded to wrap around respective side faces 187, 188 of the respective first and second layers 185, 186 to tuck between the first and second layers. In FIG. 9A, the strip 160 of susceptor material and sheet 180 of wicking material prior to any folding operations being performed are shown with a solid, unbroken outline, whereas the strip 160 and wicking element 18 after performing different ones of the folding operations is shown in broken outline. FIGS. 9B and 9C shows a side elevation view and a perspective view of the susceptor assembly 123 resulting from the strip 160 of susceptor material having been folded together with the sheet 180 of wicking material, to form susceptor element 16 wrapping around the central region of wicking element 18. The tucked-in ends 161, 162 of the strip 160 maintain a clearance ‘e’ between opposing surfaces of the first and second layers 185, 186 of the wicking element 18.

FIG. 10A shows a further alternative embodiment, in which a strip 160 of susceptor material is initially located against a corresponding sheet of 180 of wicking material. First and second legs 165, 166 are defined at respective first and second ends 161, 162 of the strip 160. The first and second legs 165, 166 are laterally offset from each other-as shown in FIG. 10B. The strip 160 is subjected to a series of folding operations (represented by the arrows in FIG. 10A). In a first one of the folding operations, the strip 160 of susceptor material and the sheet 180 of wicking material are folded together such that the sheet 180 of wicking material folds about a fold line 184 (extending into and out from the page in FIG. 10A) to form a wicking element 18 having a first planar layer 185 overlying a second planar layer 186. After this folding operation, the first and second ends 161, 162 of the strip 160 extend parallel to and away from upper and lower outward-facing surfaces 182, 183 of the wicking element 18. In one or more subsequent folding operations, the first and second legs 165, 166 of the first and second ends 161, 162 are folded to wrap around the combination of side faces 187, 188 of the first and second layers 185, 186. The first leg 165 extends around the combination of side faces 187, 188 to overlie part of the lower outwardly-facing surface 183 of the wicking element 18 and the second leg 166 extends around the combination of side faces 187, 188 to overlie part of the upper outwardly-facing surface 182 of the wicking element 18. FIG. 10B provides a view of the strip 160 of susceptor material and the wicking element 18 along section B B of FIG. 10A. As seen in FIG. 10B, each of the first and second legs 165, 166 are of equal length, but of reduced lateral width compared to the width of the strip w_{SE}. In FIGS. 10A and 10B, the strip 160 of susceptor material and sheet 180 of wicking material prior to any folding operations being performed are shown with a solid, unbroken outline, whereas the strip 160 and wicking element 18 after different ones of the folding operations are performed is shown in broken outline. FIG. 10C shows a perspective view of the susceptor assembly 124 resulting from the strip 160 of susceptor material having been folded together with the sheet 180 of wicking material, to form susceptor element 16. The first and second legs 165, 166 are dimensioned and arranged to be in side-by-side, non-overlapping relationship.

Although the embodiments described in relation to FIGS. 1A to 10C use a single strip 160 of susceptor material to form the susceptor element 16, in other embodiments an arrangement of a plurality of strips 160 of susceptor material may be employed, with the arrangement of the plurality of strips wrapped around a central region of the wicking element 18 to enclose the central region of the wicking element.

For any of the embodiments described in relation to the figures, it is preferred that the strip 160 of susceptor material be tightly wrapped around the wicking material 18, as this will enhance contact pressure and thermal coupling between the susceptor element 16 and the wicking material 18. Such tight wrapping of the strip 160 of susceptor material about the wicking element 18 will result in the susceptor element 16 compressing the wicking element 18.

The previous discussion of aspects of the present disclosure with reference to FIGS. 1A to 10C discusses structural features of different features of the susceptor assembly, as well as various steps involved in the manufacture of the susceptor assembly.

FIG. 11 illustrates various steps in a first embodiment of a method 1000 of manufacture of a susceptor assembly, such as the susceptor assemblies 12, 121, 122, 123, 124 described with reference to FIGS. 1A-10C. In a first step 1001, a wicking element is provided, the wicking element having first and second planar surfaces defining opposite, outward-facing surfaces of the wicking element. In a second step 1002, one or more strips 160 of susceptor material are provided. In a third step 1003, the one or more strips are wrapped around a central region of the wicking element to form an arrangement of the one or more strips overlying the first and second outward-facing surfaces of the wicking element and enclosing the central region of the wicking element. Step 1003 may include one or a series of folding operations performed on the one or more strips.

FIG. 12 illustrates various steps in a second embodiment of a method 2000 of manufacture of a susceptor assembly, being particularly applicable to the embodiments of FIGS. 9A to 9C and 10A-10C. In a first step 2001, a sheet of wicking material is provided. In a second step 2002, one or more strips of susceptor material are provided. In a third step 2003, the one or more strips are wrapped together with the sheet of wicking material to fold a first portion of the sheet of wicking material over a second portion of the sheet of wicking material to form a wicking element from the sheet of wicking material; further, the one or more strips are wrapped around a central region of the wicking element to form an arrangement of the one or more strips overlying first and second outward-facing surfaces of the wicking element and enclosing the central region of the wicking element.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number “A” is understood as “A”±10% of “A”. Within this context, a number “A” may be considered to include numerical values that are within general standard error for the measurement of the property that the number “A” modifies. The number “A”, in some instances as used in the appended claims, may deviate by the percentages enumerated above provided that the amount by which “A” deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. A susceptor assembly for an aerosol-generating system, the susceptor assembly comprising:
a wicking element having first and second planar surfaces, the first and the second planar surfaces defining opposite, outward-facing surfaces of the wicking element; and
a susceptor element comprising an arrangement of a single strip of susceptor material, the arrangement of the single strip of susceptor material being wrapped around a central region of the wicking element to overlie the first and the second outward-facing surfaces of the wicking element and enclose a central region of the wicking element,
wherein the single strip of susceptor material extends over a length between first and second ends, the single strip of susceptor material wrapping around the central region of the wicking element such that the first and the second ends extend from opposite directions along a side face of the wicking element, the side face extending between the first and the second planar outward-facing surfaces of the wicking element.

17. The susceptor assembly according to claim 16, wherein the arrangement of the single strip of susceptor material is wrapped around the central region of the wicking element so as to compress the central region.

18. The susceptor assembly according to claim 16, wherein either or both of the first and the second ends of the single strip of susceptor material is folded inwardly to embed within the wicking element.

19. The susceptor assembly according to claim 16, wherein the wicking element comprises a first planar layer overlying a second planar layer, either or both of the first and the second ends of the single strip of susceptor material being folded inwardly to wrap around a side face of one of the first layer and the second layer to tuck between the first and the second layers.

20. The susceptor assembly according to claim 16, wherein the first and the second ends are in surface contact, overlie, or intermesh with each other or a combination thereof.

21. The susceptor assembly according to claim 16, wherein each of the first and the second ends is folded inwardly to embed within the side face of the wicking element.

22. The susceptor assembly according to claim 16,
wherein the wicking element comprises a first planar layer overlying a second planar layer, and
wherein the first end of the single strip of susceptor material is folded inwardly to wrap around a side face of the first layer to tuck between the first and the second layers, and the second end of the single strip of susceptor material is folded inwardly to wrap around a side face of the second layer to tuck between the first and the second layers.

23. The susceptor assembly according to claim 16, wherein the first end of the single strip of susceptor material comprises a first leg and the second end of the single strip of susceptor material comprises a second leg, the first and the second legs being laterally offset from each other and extending in opposite directions from respective first and second adjoining portions of the single strip of susceptor material to wrap around the side face of the wicking element.

24. The susceptor assembly according to claim 23, wherein the first and the second legs are equal in length and arranged in a side-by-side, non-overlapping relationship.

25. The susceptor assembly according to claim 23, wherein the wicking element is folded about a fold line to define a first planar layer overlying a second planar layer, the first layer extending from the fold line to a side face of the first layer, the second layer extending from the fold line to a side face of the second layer, the side faces of the first and the second layers being aligned with each other to form a common side face, the first and the second legs extending in opposite directions to wrap around the common side face.

26. The susceptor assembly according to claim 25, wherein the first and the second legs wrap around the common side face such that opposing surfaces of the first and the second planar layers of the wicking element are urged into surface contact with each other.

27. A cartridge for coupling to an aerosol-generating device, the cartridge comprising:
the susceptor assembly according to claim 16; and
an internally positioned air flow channel and a reservoir for liquid aerosol-forming substrate,
the cartridge being configured to receive the susceptor assembly such that the susceptor element is positioned in the air flow channel with the reservoir in fluid communication with the wicking element of the susceptor assembly.

28. An aerosol-generating system comprising an aerosol-generating device and a cartridge according to claim 27, the aerosol-generating device comprising an inductor that at least in part surrounds the susceptor element when the cartridge is coupled to the aerosol-generating device.

29. A method of manufacturing a susceptor assembly, comprising steps of:
providing a wicking element having first and second planar surfaces, the first and the second planar surfaces defining opposite, outward-facing surfaces of the wicking element;
providing a strip of susceptor material; and
wrapping the strip around a central region of the wicking element to form an arrangement of a single strip of susceptor material overlying the first and the second outward-facing surfaces of the wicking element and enclosing the central region of the wicking element, the single strip of susceptor material extending over a length between first and second ends, the single strip of susceptor material wrapping around the central region of the wicking element such that the first and the second ends extend from opposite directions along a side face of the wicking element, the side face extending between the first and the second planar outward-facing surfaces of the wicking element.

30. A method of manufacturing a susceptor assembly, comprising steps of:
providing a sheet of wicking material;
providing a strip of susceptor material; and
wrapping the strip of susceptor material together with the sheet of wicking material to fold a first portion of the sheet of wicking material over a second portion of the sheet of wicking material to form a wicking element from the sheet of wicking material,
wherein the strip of susceptor material is wrapped around a central region of the wicking element to form an arrangement of a single strip of susceptor material overlying first and second outward-facing surfaces of the wicking element and enclosing the central region of the wicking element, the single strip of susceptor material extending over a length between first and second ends, the single strip of susceptor material wrapping around the central region of the wicking element such that the first and the second ends extend from opposite directions along a side face of the wicking element, the side face extending between the first and the second planar outward-facing surfaces of the wicking element.
